(19) United States
(12) Patent Application Publication
(10) Pub. No.: US 2011/0188743 A1
(43) Pub. Date: Aug. 4, 2011

(54) IMAGE PROCESSING APPARATUS, IMAGE PROCESSING METHOD, IMAGE PROCESSING SYSTEM, AND RECORDING MEDIUM

(75) Inventor: Hiroyuki Urushiya, Saitama-shi (JP)

(73) Assignee: CANON KABUSHIKI KAISHA, Tokyo (JP)

(21) Appl. No.: 13/012,686

(22) Filed: Jan. 24, 2011

(30) Foreign Application Priority Data
Feb. 3, 2010 (JP) 2010-022283

(51) Int. Cl. G06K 9/62; G06K 9/68

(52) U.S. Cl. 382/159; 382/224; 382/226

(57) ABSTRACT

An image processing apparatus applying image processing corresponding to a predetermined imaging region of a subject of an image obtained by capturing the imaging region to the image includes an acquisition unit configured to acquire classification information obtained by classifying a plurality of imaging regions according to characteristics of image processing corresponding to each of the imaging regions, an identification unit configured to identify, after identifying which of the groups the imaging region of the image corresponds to, which of the plurality of the imaging regions included in the corresponding group the imaging region of the image corresponds to, based on the image and the classification information, and a processing unit configured to apply the image processing corresponding to the identified imaging region to the image.

### BACKGROUND OF THE INVENTION

1. Field of the Invention

The present invention relates to a system and method useful for image processing a captured image of a subject to be examined.

2. Description of the Related Art

Digital images used for digital X-ray diagnosis or non-invasive inspection of packages and the like are treated with various types of image processing such as gradation conversion so that the quality of the images are enhanced and an accurate assessment of the images can be made. Generally, image processing needs to be performed according a region of interest (ROI) of a subject being imaged. However, the region of interest changes according to the captured position, thus image processing dedicated to each imaging region is performed.

When imaging a human body for example, the imaging regions may include various regions such as a head, a lung, and a lower limb. Accordingly, if the imaging region is set each time the image is captured, the operation workload will be heavy. Thus, techniques for expeditiously determining the image processing method to be applied to the image by identifying an imaging region of the image have been developed. According to these techniques, the operation workload when an image is captured is greatly reduced. The techniques are especially useful when an image of a critical-care patient needs to be captured or a radiological technologist is absent and a medical doctor who is not used to taking X-ray images has to capture an image.

An example of the above-mentioned techniques uses neural network algorithms for identifying the imaging region. Another technique makes use of a support vector machine (SVM) used as a dichotomic classifier with which an object group is classified into a plurality of categories. This later technique uses a binary tree, which uses a node as a classifier, in the identification of the imaging region.

However, according to the conventional techniques, there is a possibility of selecting an image processing method corresponding to a wrong imaging region due to misidentification. As a result, in some cases, image processing that is not appropriate for the imaging region of the target image has been performed.

### SUMMARY OF THE INVENTION

The present invention is directed to an image processing apparatus, an image processing method, and an image processing system capable of reducing an influence of misidentification of an imaging region on the image processing.

According to at least one embodiment of the present invention, an image processing apparatus applying image processing to an image, the image processing corresponding to a predetermined imaging region of a subject of the image to the image, the apparatus includes an acquisition unit configured to acquire classification information obtained by classifying a plurality of imaging regions according to characteristics of image processing corresponding to each of an identification unit configured to identify, after identifying which of the groups the imaging region of the image corresponds to, which of the plurality of the imaging regions included in the corresponding group the imaging region of the image corresponds to, based on the image and the classification a processing unit configured to apply the image processing corresponding to the identified imaging region to the image.

Further features and aspects of the present invention will become apparent from the following description of exemplary embodiments (with reference to the attached drawings).

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram illustrating a configuration of an X-ray imaging system according to a first exemplary embodiment of the present invention.

FIG. 2 is a conceptual diagram illustrating an imaging region group tree structure generated by an image processing apparatus.

FIG. 3 is a flowchart illustrating processing executed by the image processing apparatus.

FIG. 4 illustrates a concept of grouping.

FIG. 5 is a conceptual diagram illustrating a support vector machine.

FIG. 6A illustrates a feature vector used for discriminating a region group 1 including three imaging regions such as a chest front view, a chest side view, and a shoulder region from a region group 2 including two imaging regions such as a head front view and a head side view. FIG. 6B illustrates a feature vector used for discriminating a region group 1 from a region group 2 illustrated in FIG. 4. FIG. 6C illustrates projection data for each predetermined angle used for obtaining a bar ratio. FIG. 6D illustrates a method for classifying a group by obtaining a centroid of the projection data.

FIGS. 7A to 7C are conceptual diagrams illustrating feature vectors using feature quantity based on an organizational structure. FIG. 7A classifies a region including the head into a region group 1 and classifies other regions into a region group 2. FIG. 7B illustrates a method for obtaining a circularity ratio. FIG. 7C illustrates a feature vector used for discriminating a region group 1-1 from a region group 1-2 illustrated in FIG. 4.

FIG. 8 is a conceptual diagram illustrating a method for grouping by using characteristics of image processing and a degree of separation between groups.

FIG. 9 is a flowchart illustrating processing executed by the image processing apparatus according to a second exemplary embodiment of the present invention.

### DESCRIPTION OF THE EMBODIMENTS

Various exemplary embodiments, features, and aspects of the invention will be described in detail below with reference to the drawings. In the drawings, like reference numbers identify exemplary elements of like structure and function.

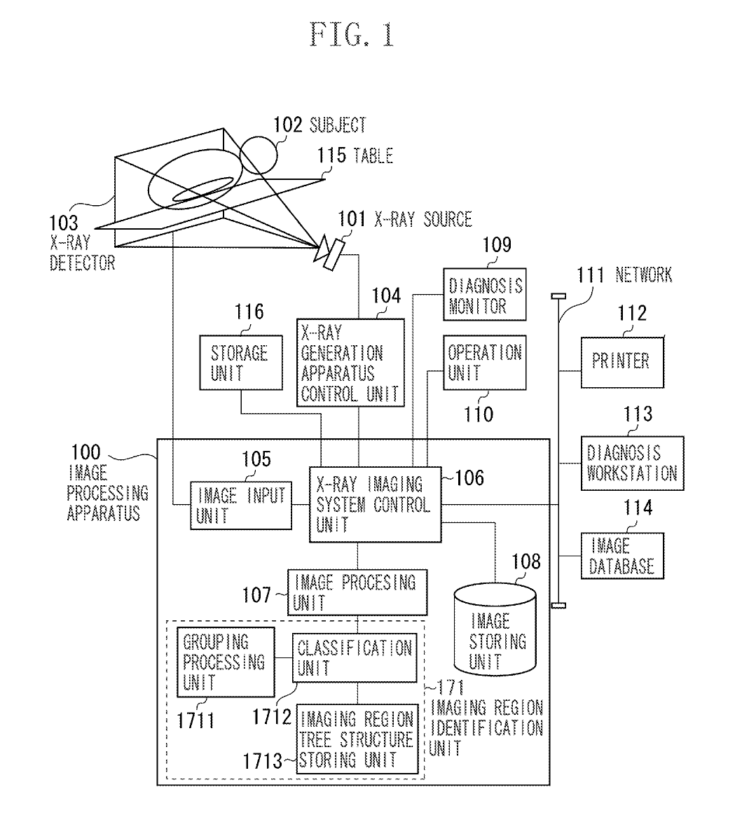

One example of the present invention is described as being applied to an X-ray imaging system as illustrated in FIG. 1. However, embodiments of the present invention may also apply to imaging techniques other than X-ray imaging. The X-ray imaging system illustrated in FIG. 1 includes an X-ray source 101 which generates an X-ray. The X-ray imaging system identifies imaging regions of images of a subject 102, which is shown lying on a platform table 115. The images of the subject are obtained by an X-ray detector 103 that detects X-ray radiation emitted from X-ray source 101 and transmitted through the subject.

Further, according to this system, before an image is provided to a person that gives diagnosis, the image is treated with certain image processing techniques suitable to identify and enhance a region of interest of the image. The identification of the imaging regions may be performed by using data in a tree structure. The data of the tree structure is obtained by classifying imaging regions according to image processing characteristics established in advance.

Next, the configuration of the X-ray imaging system will be described with reference to FIG. 1. An image processing apparatus 100 acquires an X-ray image, identifies the imaging region of the image, and performs image processing that corresponds to the imaging region.

The X-ray source 101 is a device that generates an X-ray which is irradiated onto the subject. The X-ray source 101 is controlled by an X-ray generation apparatus control unit 104. The X-ray generation apparatus control unit 104 controls a dose, an irradiation area, an X-ray tube current, an X-ray tube voltage, and irradiation start and end time of the X-ray source 101.

The X-ray generated by the X-ray source 101 is irradiated onto the subject 102. Then, a predetermined imaging region such as a lower limb or a lung field of the subject 102 is exposed to the X-ray. Since the transmissivity (absorption rate) of the X-ray depends on the organizational structure of the imaging region of the subject, the distribution of the transmitted X-ray is interpreted as showing the internal structure of the imaging region.

A detector 103 is, for example, a digital detector that detects an X-ray transmitted through the predetermined imaging region of the subject 102 and converts the detected X-ray into an electric signal. The detector 103 performs (analog-to-digital) AD conversion and offset/gain correction, and then an X-ray image is generated.

An image input unit 105 acquires the generated X-ray image and inputs the acquired image in the image processing apparatus 100. The input image is stored in a storage unit 116. An X-ray imaging system control unit 106 performs overall control of each unit of the system.

An image processing unit 107 performs image processing such as gradation conversion processing and edge enhancement processing with respect to the input image. A table which includes imaging regions, and also image processing types and parameters which correspond to the desired imaging regions (or regions of interest) is also stored in the storage unit 116. Alternatively, the table of imaging regions can be stored elsewhere, for example, in image storing unit 108 or the image database 114 within network 111.

When the image processing unit 107 performs image processing, it refers to the table of imaging regions and performs image processing that corresponds to the desired imaging region. In the description below, the imaging region is a region of the subject included in the input image and is, for example, either a lower limb or a lung field. Since the image is treated with image processing appropriate for each imaging region, diagnostic accuracy of the lesion can be improved.

An imaging region identification unit 171 includes a grouping processing unit 1711, a classification unit 1712, and an imaging region tree structure storing unit 1713. The imaging region identification unit 171 identifies an imaging region from an input image. The grouping processing unit 1711 classifies the imaging regions and generates data in a tree structure.

The data in a tree structure includes information of a group to which each imaging region belongs and information of a parent node and a child node of the group. The data in a tree structure is stored in the imaging region tree structure storing unit 1713.

The imaging region tree structure storing unit 1713 stores the data in a tree structure which is data of imaging regions separated into groups and a generated classifier. Before the data and the classifier are stored, the classifier is associated to each node of the data in a tree structure. The grouping processing will be described below.

The classification unit 1712 generates a classifier corresponding to the tree structure. According to the present exemplary embodiment, the classifier is generated by using a SVM. A parameter necessary in generating the classifier is also stored in the imaging region tree structure storing unit 1713. When the parameter is stored, it is associated with information of each group. The generation processing of the classifier will be described below.

Further, the classification unit 1712 applies the generated classifier to the image and identifies the imaging region. Information of the identified imaging region is stored together with the image in an image storing unit 108. When the information of the identified imaging region is stored, it is stored, for example, at the header portion of the image data so that it is associated with the image data.

The image storing unit 108 stores the image obtained from the image input unit 105 and the image which has undergone the processing performed by the image processing unit 107. A diagnosis monitor 109 is a display unit that displays the image which has undergone the image processing. A person that gives diagnosis such as a medical doctor conducts a diagnosis after viewing the image, which has undergone the image processing, displayed on the diagnosis monitor 109.

When the user operates an operation unit 110, an instruction is sent to the X-ray imaging system control unit 106 from the operation unit. The operation unit 110 is used for, for example, correcting the imaging region when the identification performed by the imaging region identification unit 171 is not correct.

The X-ray imaging system control unit 106 can access a printer 112, a diagnosis work station 113, and an image database 114 via a network 111. The control unit 106 controls input/output of data including image data among these units.

The storage unit 116 stores information needed to perform the operations of the X-ray imaging system. For example, a list or table of the imaging regions which can be identified by the system, a conversion equation used for the image processing corresponding to the imaging regions, and parameters are stored in the storage unit 116. Further, if the imaging region identification unit 171 is implemented as software run by the image processing apparatus 100, a program used for realizing the processing of the imaging region identification unit 171 can be stored in the storage unit 116.

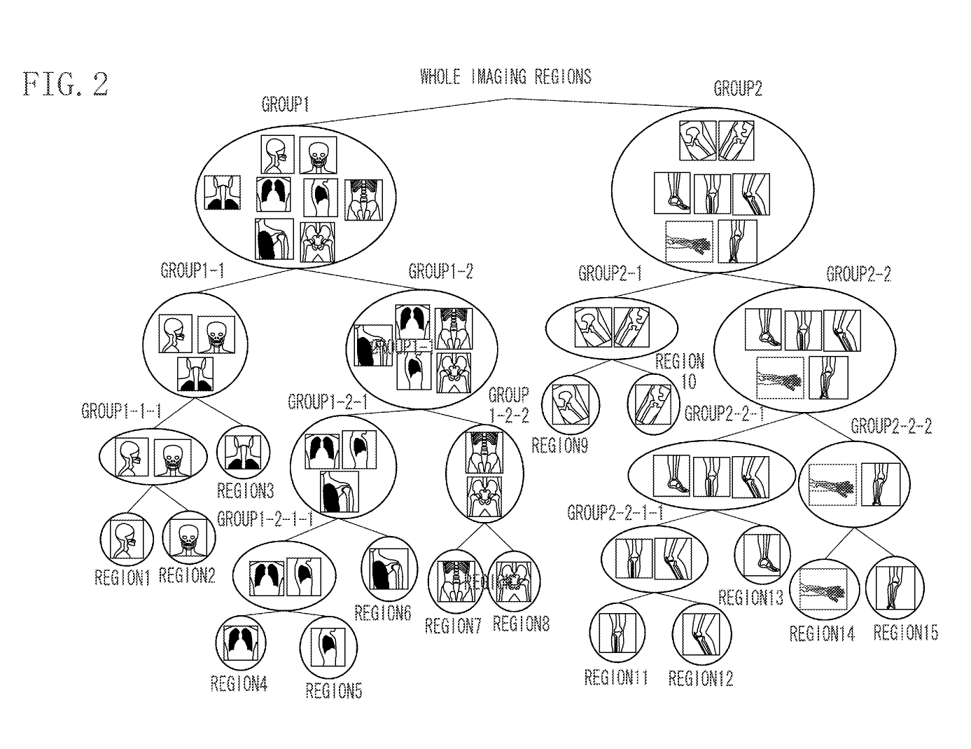

Next, the imaging region identification unit 171 will be described in detail with reference to FIG. 2. FIG. 2 illustrates a concept of the imaging region group tree structure generated by the grouping processing unit 1711.

A group that includes all of the imaging regions serves as a root node of the tree structure. The imaging regions are classified into two classes until they can no longer be classified. At that level, the imaging region corresponds to a leaf node. Nodes other than the leaf node include a plurality of imaging regions. All the imaging regions are managed according to such a tree structure. The classifier is used for separating each node into two groups of child nodes or imaging regions.

First, a two-class classifier (dichotomic classifier) which classifies all the imaging regions into two groups is generated. In FIG. 2, all the imaging regions are classified into region group 1 and region group 2. As illustrated in FIG. 2, region group 1 and region group 2 may each include a plurality of imaging regions, for example, upper body regions and lower body regions, respectively. In turn, each group is successively classified into sub-groups of two in accordance with predetermined imaging regions. The number of possible classification of the two groups equals to the number of combinations obtained in classifying all the imaging regions into two. The imaging regions are selected according to optimum classification. The optimum classification is determined according to image processing characteristics which are determined according to the imaging region.

Next, the concept of the classification is described below. When a plurality of imaging regions in a group are classified, even if one of the imaging regions is identified as a different imaging region and classified, if the impact of the misidentification is small, the plurality of imaging regions are set as a group and treated as one set of imaging regions.

The greatest influence of misclassification on the image processing is seen when image processing is performed according to information (parameter) set for a misclassified imaging region. Since the operator is unable to recognize that inappropriate image processing has been performed, even if a portion of an image is enhanced by inappropriate image processing, the person that gives diagnosis may consider that the portion is an abnormal portion of the subject. This may cause misdiagnosis.

Conversely, even if correct classification is not performed, if the image processing information (parameter) set for the incorrectly-classified imaging region is the same as the image processing information set for the correctly-classified imaging region, or if the difference is so slight that it does not affect the image quality, the image processing will not cause a bad effect with respect to the image.

Thus, a set of imaging regions with similar image processing characteristics are set in a same group. According to such classification concept, classification information in a binary tree structure where a set of imaging regions is sequentially classified into groups of imaging regions having similar image processing characteristics is acquired. Then, the imaging regions of images are identified according to this classification information.

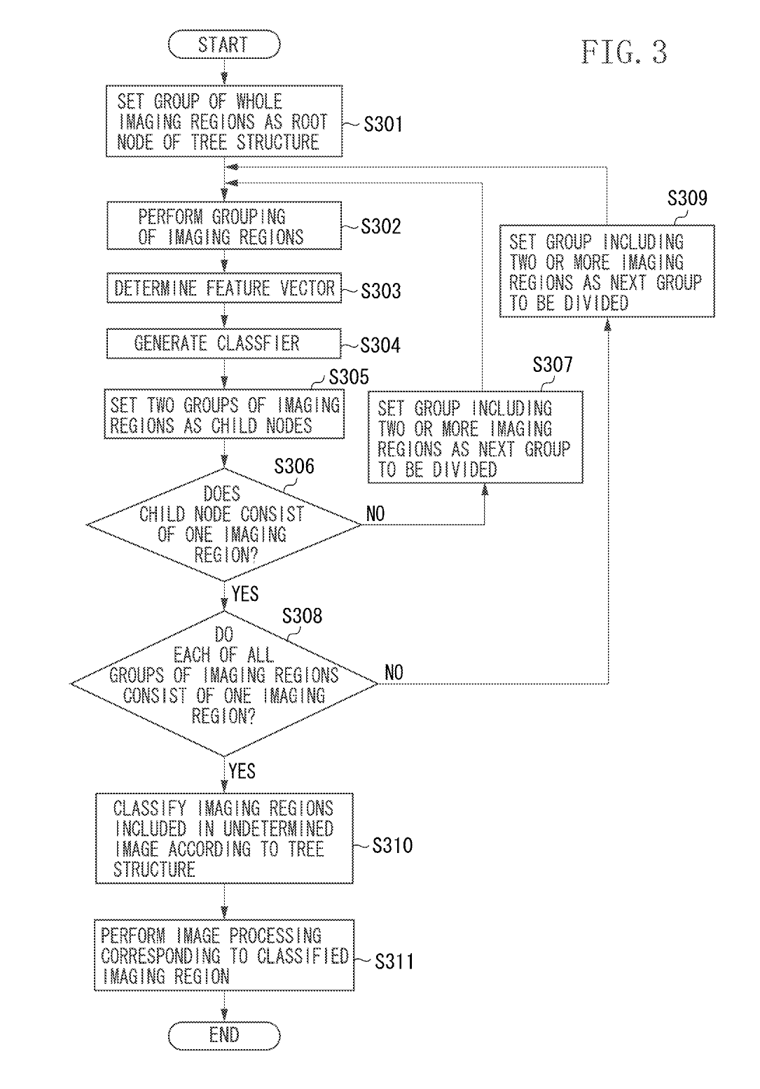

Next, processing flow of the image processing apparatus 100 including the above-described configuration and function will be described with reference to the flowchart in FIG. 3. The processing in FIG. 3 is mainly performed by the image processing unit 107 and the imaging region identification unit 171 under the control of the X-ray imaging system control unit 106.

In step S301, the grouping processing unit 1711 of the image processing apparatus 100 looks up to the list or table of the imaging regions stored in the storage unit 116 and sets a group including all the imaging regions. This group is set as a root node.

In step S302, after acquiring a plurality of imaging regions stored in the storage unit 116 and image processing characteristics corresponding to the imaging regions, the grouping processing unit 1711 performs grouping of the imaging regions according to the characteristics.

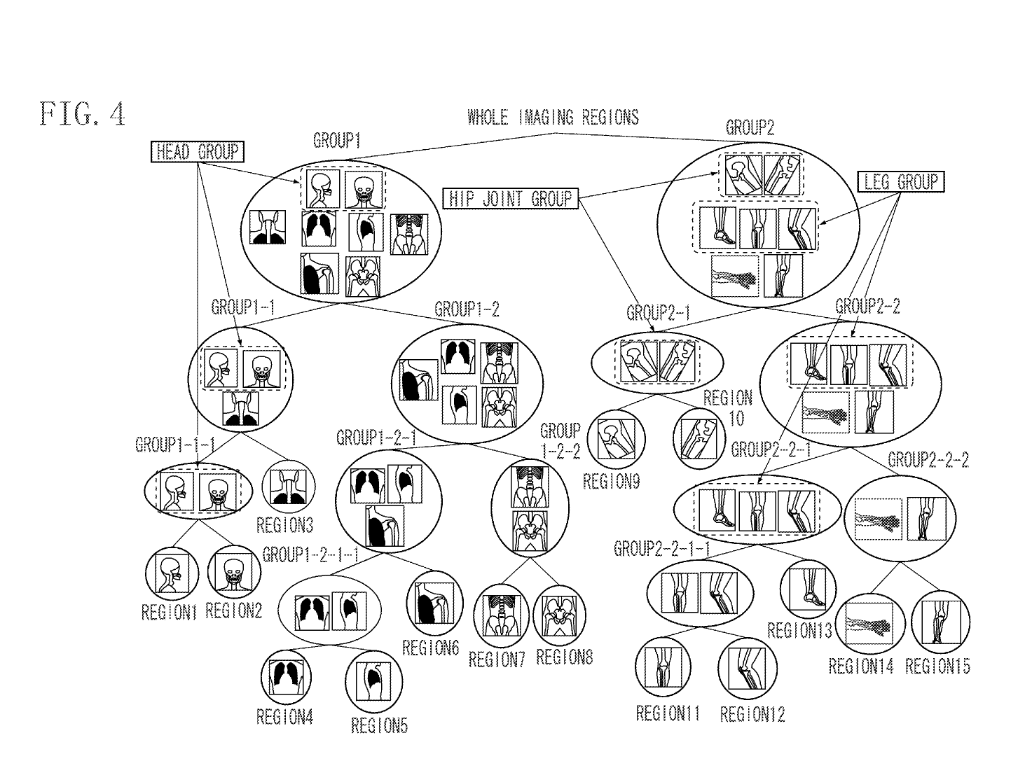

The concept of grouping performed by the grouping processing unit 1711 is described with reference to FIG. 4. In FIG. 4, each of a head group (head front view and head side view), a leg group (ankle, knee, and thighbone), and a hip joint group (right and left hip joints) is indicated by a dotted line as a group set. Each group set is treated in such a manner that when the grouping is performed, the imaging regions included in the group set are always in a same group. Finally, when a group includes only the imaging regions of the group set, the group is separated into the imaging regions.

The generation of a group is performed according to the image processing characteristics. For example, if the image processing is gradation conversion, grouping is performed according to a curve of a conversion curve used for the gradation conversion. If the imaging regions have a similar gradation conversion curve, it means that the density areas to be enhanced are similar. Thus, even if the classification of the imaging regions in such a group is not successful, the influence of the misclassification on the image after the processing is minimized.

Further, as another example, the grouping can be performed according to pixel values of a particular region, which is a reference region. In this case, the grouping is performed so that the pixel values are distributed in a certain range. This is because, in a case where a particular region of a subject is important in giving the diagnosis, even if misclassification occurs, the classification error may be acceptable if the density of the pixel values in the particular region is within a certain range.

As another example, if processing regarding frequency band is performed, a plurality of imaging regions which are treated with same processing with respect to frequency components of a certain range can be set as a group. Further, if processing regarding enhancement of edge component of an image is performed, imaging regions having similar edge components to be enhanced can be set as a group.

Since the image for diagnosis is treated with various types of processing such as sharpening and gradation conversion, similarity of the imaging regions can be set as a setting value in consideration of the influence on the whole image processing. Further, the grouping may be performed based on the processing that has the most influence on the diagnosis.

The similarity or the setting value can be set by the user as a value that determines a maximum allowable range of influence on the diagnosis. The grouping can be performed according to the user's operation. However, the similarity can also be determined automatically. If the similarity is based on gradation conversion curve, the similarity is determined with reference to a parameter that defines the gradation conversion curve, and the grouping is performed based on whether the similarity is within a certain range.

Next, in step S303, the generation processing of the classifier is started. In step S303, the classification unit 1712 determines a feature vector from each group determined in step S301. A value that can easily separate the group is set as the feature vector. Setting processing of the feature vector will be described below.

In step S304, the classifier is determined. In other words, the classification unit 1712 performs grouping of learning images (labeled images) stored in the image database 114 and whose imaging regions are identified, so that they are grouped into determined groups. Then, the classification unit 1712 extracts a feature quantity from the images of each group, and generates a classifier used for the classification of each group according to the support vector machine method. This processing is also described below. The generated classifier is stored in the imaging region tree structure storing unit 1713 in association with each node of the tree structure.

In step S305, the grouping processing unit 1711 sets the two imaging region groups generated according to the grouping as child nodes having the node being the object of the grouping as the parent node. This information is stored in the imaging region tree structure storing unit 1713.

In step S306, the grouping processing unit 1711 determines whether the imaging region groups which are targets of the classification include only one imaging region, in other words, whether the groups obtained by the classification do not include a plurality of imaging regions. The grouping processing unit 1711 makes the determination by referring to the information stored in the imaging region tree structure storing unit 1713.

In step S306, if the group which has been set as a child node includes a plurality of imaging regions (NO in step S306)), the processing proceeds to step S307. In step S307, the grouping processing unit 1711 sets the group of the child node as an object of the division, and then the processing returns to step S302.

In step S306, if the group set as a child node includes only one imaging region (YES in step S306), the processing proceeds to step S308. In step S308, the grouping processing unit 1711 refers to the imaging region tree structure storing unit 1713 and determines whether each of the groups being the leaf nodes of the tree structure includes only one imaging region.

If any one of the groups of the leaf nodes includes a plurality of imaging regions (NO in step S308), the processing proceeds to step S309. In step S309, the grouping processing unit 1711 sets a group of a leaf node that includes a plurality of imaging regions as an object of the next grouping. On the other hand, in step S308, if each of the leaf nodes includes only one imaging region (YES in step S308), the generation of the tree structure ends.

In this manner, the grouping and the determination of the classifier (dichotomic classifier) are sequentially repeated until each group includes only one imaging region. When this operation is completed, an imaging region group tree structure illustrated in FIG. 4 is generated.

When the generation of the imaging region group tree structure is finished, the processing proceeds to step S310. In step S310, the classification unit 1712 executes identification processing of the image whose imaging region is not yet identified. The classification unit 1712 executes the identification processing of an X-ray image acquired from the image input unit 105 or an image in the image database 114 by using the tree structure and the classifier stored in the imaging region tree structure storing unit 1713.

This processing is performed by applying a classifier generated by using the support vector machine method to an obtained unknown X-ray image. First, a feature vector of the X-ray image is obtained. Then, the obtained feature vector is applied to the classifier which is used for identifying which of group 1 or group 2 the imaging region belongs to. When the group to which the imaging region belongs to is identified, according to a classifier associated with that group, a child node of the group to which the imaging region corresponds to is identified.

For example, if it is determined that the imaging region belongs to region group 1, then the imaging region is subjected to a dichotomic classifier used for determining whether the image belongs to region group 1-1 or region group 1-2, so that the imaging region is identified whether it belongs to the region group 1-1 or the region group 1-2. Thus, after the imaging region is subjected to identification used for determining which of the two groups the imaging region corresponds to (i.e., first identification), the imaging region in the group is furthermore identified according to the imaging regions included in the group (second identification).

Such processing is executed according to the tree structure. When a corresponding leaf node is found, the identification processing ends. The imaging region associated with the leaf node is identified as the imaging region of the acquired image.

In step S311, the image processing unit 107 acquires an image processing method corresponding to the identified imaging region from the storage unit 116, and applies the acquired image processing to the image. The image processing is processing such as gradation conversion or edge enhancement which is performed so that the original image, obtained by AD conversion of the signal output from the detector, can be used for the diagnosis.

By using this imaging region group tree structure, an imaging region of a newly-captured digital X-ray image can be identified. Further, since groups of higher order include many samples of imaging regions, a classifier of higher reliability can be generated.

Further, if identification of the groups of higher order is successful, since a group is generated according to the features of the image processing corresponding to the imaging region, even if an error is made in the identification of the imaging regions of the group, the influence of the error is limited. Accordingly, misdiagnosis due to the selection error of the image processing can be reduced.

<Generation Processing of Classifier>

In performing identification of an imaging region of an image according to the binary tree, the classification unit 1712 generates a classifier by using the learning images. The learning images are a plurality of X-ray images having the imaging regions identified in advance. Each of the imaging regions is associated with each image. The support vector machine method is used for the generation of the classifier.

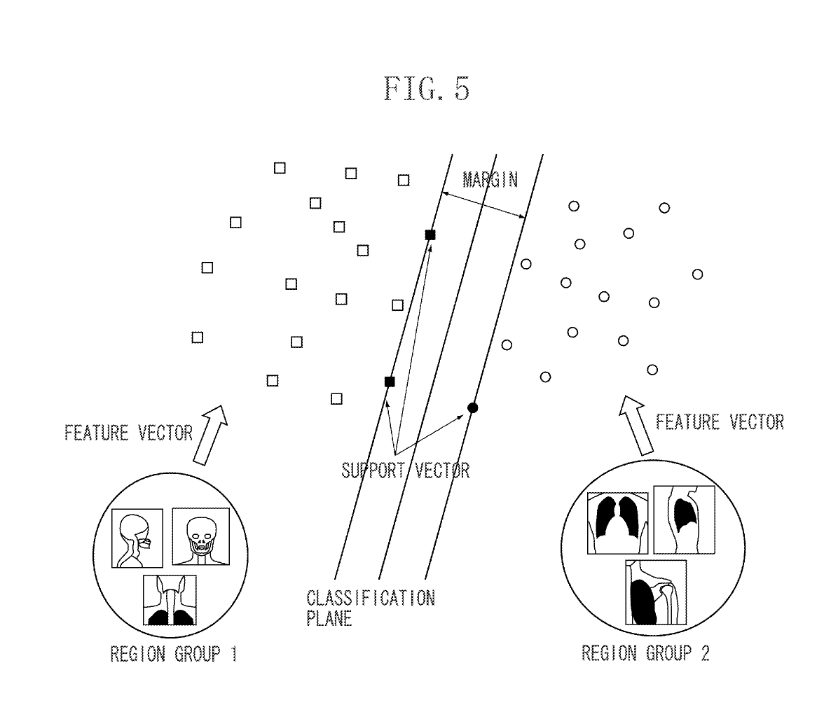

FIG. 5 is a conceptual diagram illustrating the support vector machine which is a major classifier.

When the classification is performed, the digital X-ray image is not used as it is, and a feature vector is generated from the digital X-ray image. The feature vector is generated in such a manner that the objects of the classification are clearly separated and distributed in the space. The generation of a feature vector will be described below.

In FIG. 5, an example of classification of the feature vectors into a region group 1 (head front view, head side view, and cervical spine) and a region group 2 (chest front view, chest side view, and shoulder) is illustrated.

A feature vector of the digital X-ray image whose imaging region is included in the region group 1 is represented by a square in FIG. 5. Since each of the squares is a feature vector of an image captured from a same or a similar imaging region, the squares are closely distributed. Thus, as a whole, the squares show a concentrated distribution.

Similarly, a feature vector of the digital X-ray image whose imaging region is included in the region group 2 is represented by a circle in FIG. 5. As is with the squares, the circles show a concentrated distribution. Since the feature vectors are generated so that the region group 1 and the region group 2 are clearly separated, a classification plane can be set between the distribution of the squares and the circles.

Since the feature vector is normally of high order, the classification plane is a hyperplane whose order is one level lower than the order of the feature vector. Thus, if X-ray imaging is newly performed and a digital X-ray image is obtained, by examining which side of the classification planes the feature vector exists, the imaging region of the digital X-ray image can be identified.

There are various methods for determining the classification plane. The support vector machine is one of such methods.

The support vector machine determines a classification plane according to feature vectors. First, out of the feature vectors in the region group 1, a feature vector which is closest to the distribution of the feature vectors in the region group 2 is determined. Then, out of the feature vectors in the region group 2, a feature vector which is closest to the distribution of the feature vectors in the region group 1 is determined. The classification plane is a plane where the distance between the two feature vectors is the smallest.

These feature vectors are represented by a black square and a black circle in FIG. 5 and are called support vectors. The distance between the support vectors is called a margin.

As described above, the classifier that performs the classification by determining the classification plane is a two-class classifier (dichotomic classifier). When data is input, a two-class classifier determines which of two possible classes the input is included. Since several tens of imaging regions are classified by the dichotomic classifier, the imaging region group tree structure is used for the classification.

Although the support vector machine has been described as an example of the dichotomic classifier, the dichotomic classifier of the present invention is not limited to the support vector machine, and various dichotomic classifiers using boosting method such as Adaboost and other dichotomic classifiers are also applicable. Further, small-class classifiers such as 3-class and 4-class classifiers are also applicable.

<Extraction Processing of Feature Quantity Used for Generation of Classifier>

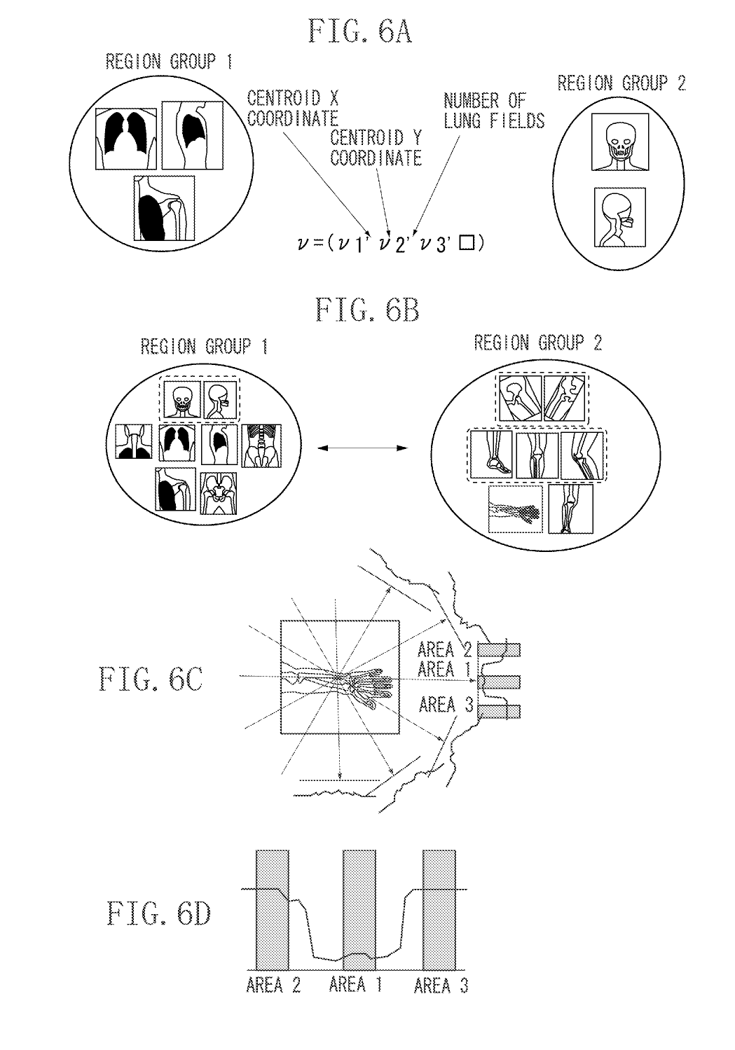

A feature vector is generated by arranging and vectorizing a plurality of feature quantities that can realize clear separation of the objects to be identified. FIG. 6A is a conceptual diagram illustrating a feature vector used for the classification of the imaging regions.

FIG. 6A illustrates an example of a feature vector used for classifying region groups into a region group 1 and a region group 2. The region group 1 includes three imaging regions such as a chest front view, a chest side view, and a shoulder. The region group 2 includes two imaging regions such as a head front view and a head side view.

Coordinates of a centroid are employed as a common feature quantity of a first factor and a second factor of the feature vector. Since the positions of the centroid of the region group 1 and the region group 2 are generally different, the centroid is a feature quantity useful in clearly separating the region group 1 from the region group 2.

There are many common feature quantities including higher-order moment such as secondary moment. If a feature quantity that can clearly separate the region group 1 and the region group 2 is selected as appropriate and added, then, a feature vector with higher separation performance can be acquired. In the following description, as a method which is furthermore effective, a feature quantity unique to the body structure is added to the feature vector.

Regarding a feature vector used for separating the region group 1 and the region group 2, a number of lung fields is employed as a third factor. In other words, a number of lung fields is extracted by applying lung field extraction processing to a digital X-ray image and the obtained number is used as a feature quantity.

Regarding the images whose imaging regions belong to the region group 1, since all the images include a lung field, the number of the lung fields will be a positive value. On the other hand, since the images whose imaging regions belong to the region group 2 do not include a lung field, the number of the lung fields will be 0.

Thus, the number of the lung fields is a feature quantity that is useful in separating the region group 1 from the region group 2.

Next, a feature quantity used in separating a region group 1 from a region group 2 illustrated in FIG. 4 will be described. In FIG. 6B, the limbs are classified into a region group 2 and other regions are classified into a region group 1. In performing the classification, a bar ratio is used as a feature quantity for separating the region groups. Since the limbs have a bar-like structure, the feature quantity can be determined by quantifying a bar-like structure of the image.

An example of obtaining a bar ratio is illustrated in FIGS. 6C and 6D. In order to obtain a bar ratio, projection data is generated for each predetermined angle as illustrated in FIG. 6C. Then, as illustrated in FIG. 6D, the centroid of the projection data is calculated, and a predetermined range having the obtained centroid at the center will be set as a range 1.

Then, a range 2 and a range 3 are determined which are set at a predetermined distance away from the range 1 and closer to either end of the projection data. The mean values of the pixel values of the ranges 1, 2, and 3 are determined as x1, x2, and x3. Then, a “y coordinate value” is calculated according to “y=x1/(x2+x3)”. The portions of “x2+x3” can be replaced, for example, by “Max[x2,x3]”.

The “y coordinate value” is calculated with respect to all angles. Then, the maximum value is set as “ymax” and the minimum value is set as “ymin”. The bar ratio is obtained by calculating ymax/ymin. A greater bar ratio is obtained from an image of the limbs and a smaller bar ratio is obtained from other regions. Accordingly, efficient separation of the images is possible.

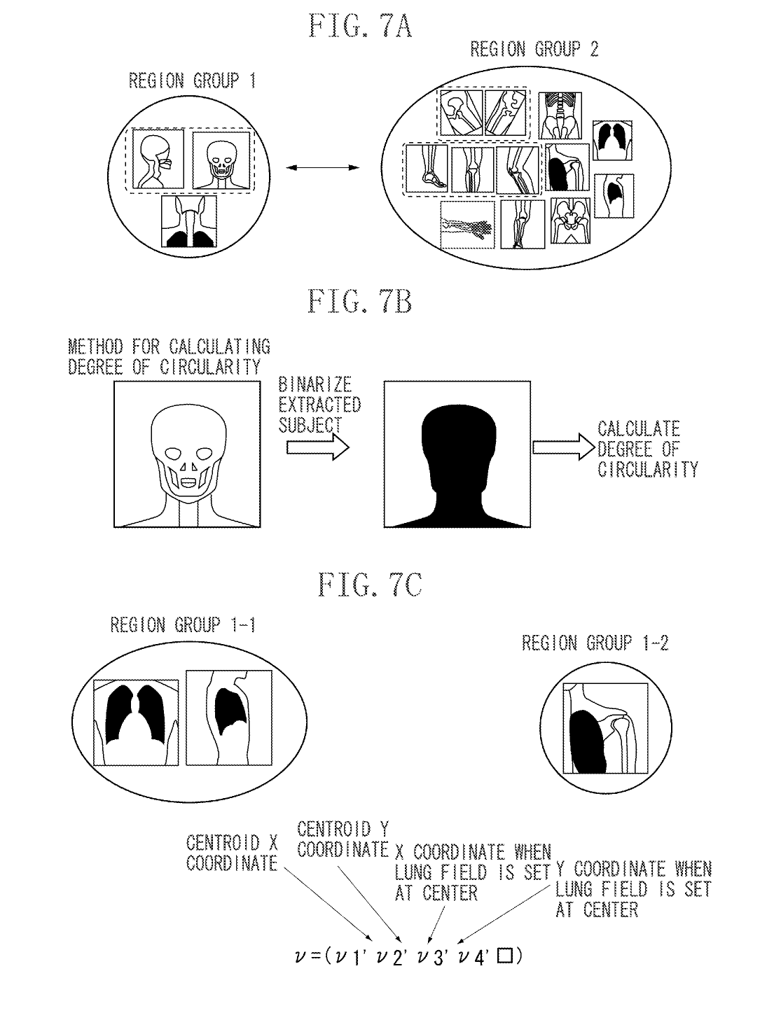

Next, an example of the feature quantity used in separating the region group 1-1 from the region group 1-2 in FIG. 4 will be described. In FIG. 7A, regions including a head portion are classified into a region group 1, and other regions are classified into a region group 2.

As a feature quantity for separating the region groups, a circularity ratio is used. Since the image of a head portion is circular, by quantifying the circular form of the image and using it as a feature quantity, the head portion can be identified.

FIG. 7B is a conceptual diagram illustrating how a circularity ratio can be obtained. In order to obtain the circularity ratio, the object is extracted from the image and binarized. The circularity ratio can also be obtained by performing binarization and considering the connected region having the maximum area as the object. After obtaining the circumference and the area of the subject area with respect to the binarized binary image, the circularity ratio is obtained by calculating (square of circumference)/area.

The calculated circularity ratio becomes smaller as the form becomes closer to a circle. Further, the circularity ratio is smaller at the image portion including the head and larger at other portions. Thus, efficient separation can be achieved.

Next, an example of a feature vector used for classification of the imaging regions which have been identified as the region group 1 (chest front view, chest side view, and shoulder) into a region group 1-1 (chest front view, chest side view) and a region group 1-2 (shoulder) is illustrated in FIG. 7C. This corresponds to the classification of the imaging regions into a group 1-2-1-1 and a region 6 illustrated in FIG. 4.

As is with the classification described above, coordinates of the centroid as a common feature quantity are employed as the first and the second factors. In a case of discriminating the region group 1-1 from the region group 1-2, since the positions of the centroid of the region group 1-1 and the region group 1-2 are generally different as is with the classification described above, the centroid is a feature quantity useful in clearly separating the region group 1-1 from the region group 1-2.

Further, as a feature quantity unique to the body structure, coordinates of the center of the lung field are employed as the third and fourth factors. The feature quantity employs the central position of the lung field extracted as described above. If two lung fields are extracted as is the case with the chest front view, a position of a median value can be used.

The central position of the lung field is at the upper portion with respect to the center of the image of the chest front view and the chest side view in the region group 1-1. The central position of the lung field is at the lower right or lower left portion with respect to the image of the shoulder in the region group 1-2. Thus, the center of the lung field is a feature quantity useful for clearly separating the region group 1-1 from the region group 1-2.

In this manner, by adding a feature quantity unique to the structure of the human body corresponding to the region group to be identified to the factors of the feature vector, classification of higher accuracy can be realized.

Needless to say, the imaging regions according to the present invention can be classified by using a feature vector based on a common feature quantity with respect to all the region groups.

Further, if a feature quantity unique to the structure of the human body is not obtained, as described above, an appropriate feature quantity can be selected as appropriate from the feature quantities, which are commonly used, such as the coordinates of the centroid of pixel values and higher-order moment.

Another problem originating from misidentification and has a great influence is a case where a wrong imaging region is set for the imaging information associated with the captured image. In such a case, incorrect imaging region information may be transferred to an external diagnosis database.

Thus, as for images of a same portion of the structure of the human body but image-captured from different angles such as a head front view and a head side view or images of similar portions of the structure of the human body such as an ankle, a knee, and a thighbone, their imaging regions are set as a group and treated as one set of imaging regions. Further, an all-inclusive imaging region (e.g., head or leg in the example above) will be set for the imaging information of such images.

In such a case, the identification to the level of “the head front view and the head side view” or “the ankle, the knee, and the thighbone” is performed. Then, image processing information (parameter) set for the identified imaging region will be used as the image processing information (parameter). As for the imaging information of the image, imaging information (parameter) set for the all-inclusive imaging region will be used.

According to the image processing apparatus of the present exemplary embodiment, since the identification of the imaging regions of an image captured by digital X-ray imaging can be performed quickly and with accuracy, operations required in selecting imaging regions are no longer necessary. Accordingly, efficiency of X-ray imaging is improved. Further, since appropriate imaging regions can be identified, appropriate image processing corresponding to the imaging regions can be selected. This contributes to stable provision of appropriate digital X-ray images and the performance of the diagnosis is therefore enhanced.

Regarding the grouping processing performed by the grouping processing unit 1711 according to the first exemplary embodiment, there are a plurality of grouping methods. For example, regarding the imaging regions whose similarity is lower than a predetermined value, the grouping is performed regardless of the similarity since the necessity to consider the similarity index is low. In such a case, the grouping may not be determined according to similarity.

Thus, grouping is performed based on the greatest degree of separation when the classification is performed. The degree of separation is an index indicating the degree of separation between two classes. If the support vector machine is used, the size of the margin corresponds to the degree of separation.

A dichotomic classifier (e.g., support vector machine) is generated for all possible combinations when the imaging regions are divided into two. Then, grouping, which realizes the greatest degree of separation (margin in the case of the support vector machine) when the imaging regions are classified by the dichotomic classifier, and the dichotomic classifier used for that grouping are employed. Since the components of the system are similar to those of the system illustrated in FIG. 1, their descriptions are not repeated.

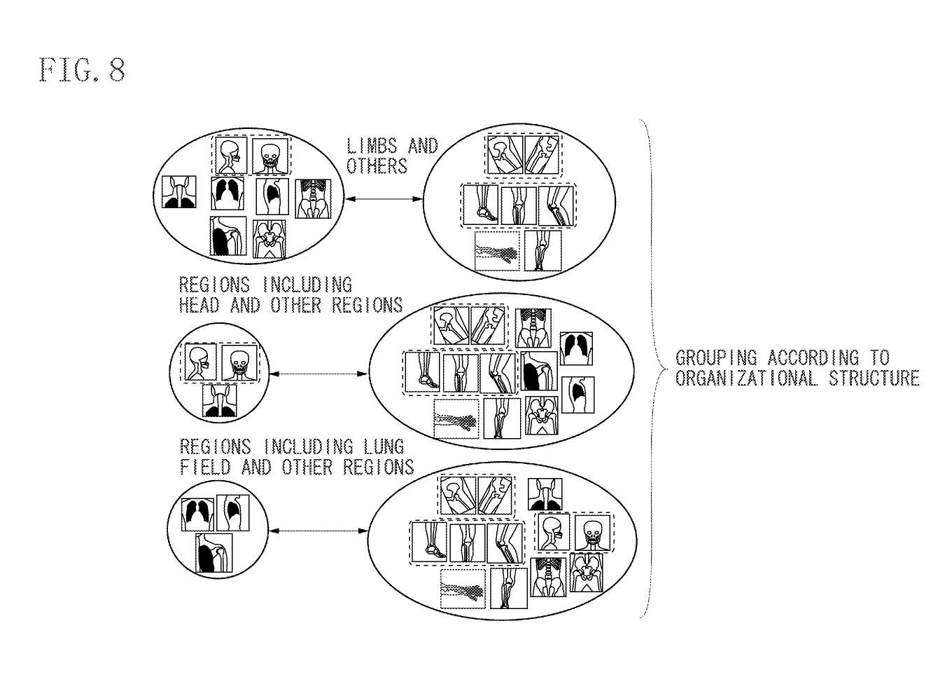

Next, an exemplary embodiment used for efficiently dividing the imaging regions will be described with reference to FIG. 8.

The dichotomic classifier is not applied to all the division combinations of all the imaging regions into two, and is applied only to the grouping corresponding to the organizational structure of the imaging regions. As for the grouping corresponding to the organizational structure, for example, grouping such as “limbs and other portions”, “portions including the head and other portions”, “portion including the lung field and other portions” is performed. Then, the grouping whose degree of separation is the greatest and the dichotomic classifier used for the grouping, are employed.

As described above, the grouping, which divides the whole imaging regions into region groups 1 and 2, and the dichotomic classifier used for the separation are determined. Then, by using a similar method, each of the divided region groups 1 and 2 are divided respectively into two region groups, i.e., region groups 1-1 and 1-2, and region groups 2-1 and 2-2, and the dichotomic classifiers are determined.

However, as for the grouping corresponding to the organizational structure, grouping corresponding to appropriate organizational structure is selected and performed in dividing each group.

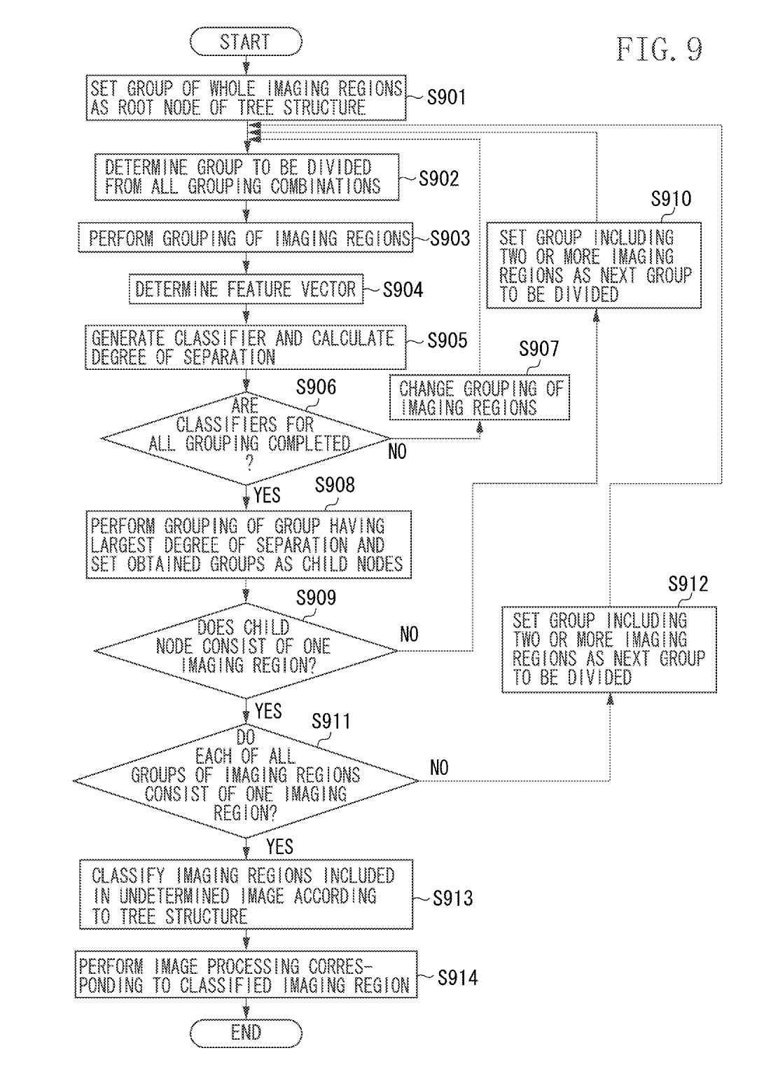

The flow of processing executed by the image processing apparatus 100 will be described with reference to a flowchart illustrated in FIG. 9. Descriptions of the steps similar to those described according to the first exemplary embodiment are not repeated.

Step S901 is similar to S301. In step S902, a plurality of candidates for the grouping are determined according to the characteristics of the image processing. The grouping is performed in the same manner as the grouping according to the first exemplary embodiment. Steps S902, S903 and S904 are equivalent to steps S302, S303 and S304, respectively.

In step S905, the classifier is generated, and the degree of separation between groups is calculated according to the generated classifier. The degree of separation is calculated based on a margin value if the support vector machine method is used. If the support vector machine method is not used, the degree of separation is defined by, for example, using the distance between the centroid value of each group or a standard deviation of each group.

In step S906, the grouping processing unit 1711 determines whether classifiers are determined for all the grouping performed in step S902. If classifiers for all the grouping are not yet determined (NO in step S906), the processing proceeds to step S907. In step S907, the grouping is changed, and the processing returns to step S902. On the other hand, if classifiers for all the grouping are determined (YES in step S906), the processing proceeds to step S908.

In step S908, the grouping processing unit 1711 selects the grouping with the greatest degree of separation between groups out of the grouping performed in step S902, and sets the groups obtained from the grouping as child nodes. Steps S909 through step S914 are equivalent to steps S306 through steps S311, respectively.

In this manner, by selecting the grouping with the greatest degree of separation between groups, grouping that contributes to high classification rate is realized, and a dichotomic classifier that realizes such classification can be generated.

According to the present exemplary embodiment, the grouping is performed according to the number of the learning images used when a classifier is used. A method for generating an imaging region group tree structure with high accuracy, which is useful for the actual operation, will be described. The imaging region group tree structure is generated by using learning data which is used when an imaging region group tree structure illustrated in FIG. 8 is generated. The number of pieces of the learning data used for generating the tree structure corresponds to the number of images of each imaging region according to image capturing frequency.

By using this method, the ratio of the imaging regions included in the learning data is increased as the image of the imaging region is more frequently captured. Thus, possibility of the imaging region identified as a different imaging region due to an error can be decreased. Thus, possibility of an error in determining an imaging region which is frequently captured will be decreased, and stable image processing can be performed.

According to the above-described exemplary embodiment, if a classifier other than a dichotomic classifier is also used, it is necessary to determine whether the group is to be divided into two or divided into more groups. At that time, the grouping processing unit 1711 determines the number of groups according to the characteristics of the image processing or the degree of separation between groups.

If similarity of characteristics of image processing of one group is determined as a predetermined range, a plurality of groups that satisfy that condition are generated. In this manner, influence of misidentification of the imaging regions in the group can be reduced.

Further, the number of groups can be set by using the degree of separation between groups as a threshold value. In this manner, identification rate of identification in units of groups can be improved.

According to the above-described exemplary embodiments, the classification is performed according to the tree structure until the groups are classified into each imaging region. However, if the purpose of the classification of the imaging region is to determine the image processing to be applied, it is not always necessary to classify the imaging regions. In such a case, classification of imaging regions which are treated with same image processing may not be performed.

Further, from a different viewpoint, another case that originates from misclassification and has a great influence is where wrong imaging region is set as the imaging information associated with the captured image. In such a case, incorrect imaging region information may be transferred to an external diagnosis database.

Thus, as for images of a same portion of the structure of the human body but image-captured from different angles such as a head front view and a head side view or images of similar portions of the structure of the human body such as an ankle, a knee, and a thighbone, their imaging regions are collected and treated as one set of imaging regions.

As for the imaging information of the image, imaging information (parameter) set for the all-inclusive imaging region can be used. In such a case, the identification to the level of “the head front view and the head side view” or “the ankle, the knee, and the thighbone” is performed. Then, image processing information (parameter) set for the identified imaging region will be used as the image processing information (parameter). As for the imaging information of the image, imaging information (parameter) set for the all-inclusive imaging region will be used.

According to the above-described exemplary embodiments, identification processing of the present invention is applied to the X-ray image obtained by the X-ray imaging system. However, the identification processing can be applied to an object other than such an X-ray image. For example, the exemplary embodiments are applicable to an image for diagnosis captured by an apparatus, such as a magnetic resonance imaging (MRI) apparatus or an ultrasound imaging equipment, which captures an image of a plurality of different regions of a subject. Further, the subject is not limited to a human, and an animal or an object to be examined can also be the subject.

Further, according to the above-described exemplary embodiments, although the image processing apparatus 100 executes the processing illustrated in FIGS. 3 and 9, the present invention is also realized by an image processing system including another device instead of part of the configuration of the image processing apparatus 100.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2010-022283 filed Feb. 3, 2010, which is hereby incorporated by reference herein in its entirety.

What is claimed is:

1. An image processing apparatus applying image processing to an image, the image processing corresponding to a predetermined imaging region of a subject of the image to the image, the apparatus comprising:
an acquisition unit configured to acquire classification information obtained by classifying a plurality of imaging regions according to characteristics of image processing corresponding to each of the imaging regions;
an identification unit configured to identify, after identifying which of the groups the imaging region of the image corresponds to, which of the plurality of the imaging regions included in the corresponding group the imaging region of the image corresponds to, based on the image and the classification information; and
a processing unit configured to apply the image processing corresponding to the identified imaging region to the image.

2. The image processing apparatus according to claim 1, wherein the classification information is information obtained by classifying the plurality of imaging regions into groups where density of a particular region of the image is within a predetermined range as a result of the image processing corresponding to each of the imaging regions.

3. The image processing apparatus according to claim 1, wherein the classification information is information obtained by classifying the plurality of imaging regions into groups where a parameter of image processing corresponding to each of the imaging regions is similar.

4. The image processing apparatus according to claim 1, wherein the classification information is classification information in which grouping having greater degree of separation of groups is selected out of a plurality of candidates of grouping determined according to the characteristics of the image processing.

5. The image processing apparatus according to claim 1, further comprising a determination unit configured to determine a number of groups into which the imaging regions are divided according to at least either of image processing characteristics corresponding to the imaging region or degree of separation between the groups.

6. The image processing apparatus according to claim 1, wherein the group includes at least one of the groups or the imaging regions.

7. The image processing apparatus according to claim 6, wherein the imaging region is managed by using a tree structure having a group as a node, a group including all the imaging regions as a root node, and an imaging region as a leaf node.

8. The image processing apparatus according to claim 1, wherein the identification unit identifies an imaging region of the image obtained by imaging the subject by using a identifier generated by applying a support vector machine method to a learning image that is associated with information of the imaging region.

9. The image processing apparatus according to claim 1, wherein the image processing is either gradation conversion processing or edge enhancement processing.

10. An image processing system comprising an image processing apparatus according to claim 1 and a display unit configured to display the processed image.

11. An image processing method comprising:
acquiring a plurality of candidates of imaging regions corresponding to an image obtained by imaging a subject and characteristics of gradation conversion corresponding to the candidates of the imaging regions;
generating a group of the candidates according to the obtained characteristics of the gradation conversion; and
after identifying which of the groups the image corresponds to, identifying which of the candidates of imaging regions included in the corresponding group that the image corresponds to.

12. A non-transitory computer-readable recording medium recording a program that causes a computer to execute image processing corresponding to a region of an image obtained by imaging a subject, the image processing comprising:
classifying a plurality of imaging regions into groups according to characteristics of image processing corresponding to each of the imaging regions;
after identifying the group to which the image corresponds, identifying to which imaging region included in the corresponding group the image corresponds to; and
applying image processing corresponding to the identified imaging region to the image.

13. An image processing apparatus configured to apply image processing to an image based on an identified image region thereof, the apparatus comprising:
an input unit configured to input a plurality of images into the image processing apparatus;
an image region identification unit configured to identify an imaging region in each of the input images based on the predetermined imaging regions;
an image region classification unit configured to form groups of imaging regions by classifying the identified imaging regions into groups;
a group processing unit configured to generate a data tree structure based on the groups of imaging regions, wherein each node of the tree structure corresponds to a group and each group corresponds to at most one type of imaging region; and
an image processing unit configured to apply the image processing type to the image based on the identified imaging region of the image and the group to which the imaging region belongs to.

14. The image processing apparatus according to claim 13, wherein the imaging region classification unit includes a dichotomic classifier which successively classifies the identified imaging regions into two groups until the identified imaging regions can no longer be classified.

15. The image processing apparatus according to claim 13, wherein the group processing unit generates the data tree structure using a binary tree structure such that each node of the tree structure is sequentially generated based on predetermined image processing characteristics.

16. The image processing apparatus according to claim 15, wherein the predetermined image processing characteristics include at least one of a gradation conversion, a density of pixel values, a degree of circularity, and a feature quantity unique to a centroid of the identified imaging region of the image.
